(19) United States
(12) Patent Application Publication
(10) Pub. No.: US 2009/0210653 A1
(43) Pub. Date: Aug. 20, 2009

(54) METHOD AND DEVICE FOR TREATING AND PROCESSING DATA

(75) Inventors: Martin Vorbach, D-80689 München (DE); Volker Baumgarte, 81677D-München (DE); Armin Nückel, 76777 Neupotz (DE); Frank May, D-81927 München (DE)

Correspondence Address: KENYON & KENYON LLP, ONE BROADWAY, NEW YORK, NY, 10004, US

(73) Assignee: PACT XPP TECHNOLOGIES AG, Munich (DE)

(21) Appl. No.: 12/389,116

(22) Filed: Feb. 19, 2009

Related U.S. Application Data
(63) Continuation of application No. 10/469,910, filed on Feb. 17, 2005.
(60) Provisional application No. 60/317,876, filed on Sep. 7, 2001.

(30) Foreign Application Priority Data
Mar. 5, 2001 (DE) 101 10 530.4
Mar. 7, 2001 (DE) 101 11 014.6
Jun. 20, 2001 (DE) 101 29 237.6
Jun. 20, 2001 (EP) 01115021.6
Jul. 24, 2001 (DE) 101 35 210.7
Jul. 24, 2001 (DE) 101 35 211.5
Aug. 16, 2001 (DE) 101 39 170.6
Aug. 29, 2001 (DE) 101 42 231.8
Sep. 3, 2001 (DE) 101 42 894.4
Sep. 3, 2001 (DE) 101 42 903.7
Sep. 3, 2001 (DE) 101 42 904.5
Sep. 11, 2001 (DE) 101 44 732.9
Sep. 11, 2001 (DE) 101 44 733.7
Sep. 17, 2001 (DE) 101 45 792.8
Sep. 17, 2001 (DE) 101 45 795.2
Sep. 19, 2001 (DE) 101 46 132.1
Nov. 5, 2001 (DE) 101 54 259.3
Nov. 5, 2001 (DE) 101 54 260.7
Dec. 14, 2001 (EP) 01129923.7
Jan. 18, 2002 (EP) 02001331.4
Jan. 19, 2002 (DE) 102 02 044.2
Jan. 20, 2002 (DE) 102 02 175.9
Feb. 15, 2002 (DE) 102 06 653.1
Feb. 18, 2002 (DE) 102 06 856.9
Feb. 18, 2002 (DE) 102 06 857.7
Feb. 21, 2002 (DE) 102 07 224.8
Feb. 21, 2002 (DE) 102 07 225.6
Feb. 21, 2002 (DE) 102 07 226.4
Feb. 27, 2002 (DE) 102 08 434.3
Feb. 27, 2002 (DE) 102 08 435.1

(51) Int. Cl. G06F 15/80; G06F 9/06

(52) U.S. Cl. 712/22; 712/E09.003

(57) ABSTRACT

Procedures and methods for managing and transmitting data within multidimensional systems of transmitters and receivers are described. Splitting a data stream into a plurality of independent branches and subsequent merging of the individual branches to form a data stream is to be performable in a simple manner, the individual data streams being recombined in the correct sequence. This method may be particularly useful for executing reentrant code. The method is well suited, in particular, for configurable architectures; particular attention is paid to the efficient control of configuration and reconfiguration.

### BACKGROUND INFORMATION

The present invention relates to procedures and methods for managing and transferring data within multidimensional systems of transmitters and receivers. Splitting a data stream into a plurality of independent branches and subsequent merging of the individual branches to form a data stream is to be performable in a simple manner, the individual data streams being recombined in the correct sequence This method may be of importance, in particular, for executing reentrant code. The method described herein may be well suited, in particular, for configurable architectures; particular attention is paid to the efficient control of configuration and reconfiguration.

Reconfigurable architecture includes modules (VPU) having a configurable function and/or interconnection, in particular integrated modules having a plurality of unidimensionally or multidimensionally positioned arithmetic and/or logic and/or analog and/or storage and/or internally/externally interconnecting modules, which are connected to one another directly or via a bus system.

These generic modules include in particular systolic arrays, neural networks, multiprocessor systems, processors with a plurality of arithmetic units and/or logic cells and/or communication/peripheral cells (IO), interconnecting and networking modules such as crossbar switches, as well as conventional modules of the type FPGA, DPGA, Chameleon, XPUTER, etc. Reference is also made in particular in this context to the following patents and patent applications: DE 44 16 881.0-53, DE 197 81 412.3, DE 197 81 483.2, DE 196 54 846.2-53, DE 196 54 593.5-53, DE 197 04 044.6-53, DE 198 80 129.7, DE 198 61 088.2-53, DE 199 80 312.9, PCT/DE 00/01869, DE 100 36 627.9-33, DE 100 28 397.7, DE 101 10 530.4, DE 101 11 014.6, PCT/EP 00/10516, EP 01 102 674.7, PACT02, PACT04, PACT05, PACT08, PACT10, PACT11, PACT13, PACT21, PACT13, PACT15b, PACT18(a), PACT25(a,b), each of which is expressly incorporated herein by reference in its entirety.

The above-mentioned architecture is used as an example to illustrate the present invention and is referred to hereinafter as VPU. The architecture includes an arbitrary number of logic (including memory) and/or memory cells and/or networking cells and/or communication/peripheral (IO) cells (PAEs—Processing Array Elements) which may be positioned to form a unidimensional or multidimensional matrix (PA); the matrix may have different cells of any desired configuration. Bus systems are also understood here as cells. A configuration unit (CT) which affects the interconnection and function of the PA is assigned to the entire matrix or parts thereof.

### BRIEF DESCRIPTION OF THE DRAWINGS

FIG. 1a shows a configuration of a pipeline within a VPU.

FIG. 1b shows a section of stages.

FIG. 1c shows the principle of the example method.

FIG. 1d shows an example embodiment having two receivers.

FIG. 2 shows a first embodiment of implementation.

FIG. 3 shows an implementation with a plurality of transmitters.

FIG. 4 shows an example embodiment of the present invention.

FIG. 5 shows an example configuration of a bus system.

FIGS. 6a and 6b shows and example of a simple arbiter for a bus node.

FIGS. 7a-c show examples of a local merge.

FIG. 8 shows an example FIFO.

FIGS. 9 and 9a show an example FIFO stage, and an example of cascaded FIFO stages.

FIGS. 10a and 10b show appending and removing a data word.

FIG. 11 shows an example tree.

FIGS. 12a and 12b show a wide graph and partitioning a wide graph.

FIGS. 13a and 13b show further details of partitioning.

FIG. 14 shows an example of an identification between arrays made up of reconfigurable elements (PAEs) of two VPUs.

FIG. 15 shows an example sequencer.

FIGS. 16a-c show an example of re-sorting of an SIMD-WORD.

### DETAILED DESCRIPTION

The configurable cells of a VPU must be synchronized for the proper processing of data. Two different protocols are used for this purpose; one for the synchronization of the data traffic and another one for sequence control of the data processing. Data is preferably transmitted via a plurality of configurable bus systems. Configurable bus system means in particular that any PAEs transmit data and the connection to the receiving PAEs and the receiving PAEs themselves in particular are configurable in any desired manner.

The data traffic is preferably synchronized using handshake protocols, which are transmitted with the data. In the following description, simple handshakes as well as complex procedures are described, whose preferred use depends on the particular application to be executed or the amount of applications.

Sequence control takes place via signals (triggers) which indicate the status of a PAE. Triggers may be transmitted independently of the data via freely configurable bus systems, i.e., they may have different transmitters and/or receivers and preferably also have handshake protocols. Triggers are generated by a status of a transmitting PAE (e.g., zero flag, overflow flag, negative flag) by relaying individual states or combinations.

Data processing cells (PAEs) within a VPU may assume different processing states, which depend on the configuration status of the cells and/or incoming or received triggers:

“not configured”:

no data processing

“configured”:

GO all incoming data is computed.

STOP incoming data is not computed.

STEP one computation is performed.

GO, STOP, and STEP are triggered by the triggers described below:

### Handshake Synchronization

A particularly simple yet powerful handshake protocol, which is preferably used when transmitting data and triggers, is described in the following. The control of the handshake protocol is preferably hard-wired in the hardware and may be an important component of a VPU's data processing paradigm. The principles of this protocol have been described in PACT02.

A RDY signal which indicates the validity of the information is also transmitted with each piece of information transmitted by a transmitter via any bus.

The receiver only processes information that is provided with a RDY signal; all other information is ignored.

As soon as the information has been processed by the receiver and the receiver is able to receive new information, it indicates, by sending an acknowledgment signal (ACK) to the transmitter, that the transmitter may transmit new information. The transmitter always waits for the arrival of ACK before it sends data again.

A distinction is made between two operating modes:

a) “dependent”: All inputs that receive information must have a valid RDY before the information is processed. Then ACK is generated.

b) “independent”: as soon as an input that receives information has a valid RDY, an ACK is generated for this particular input if the input is able to receive data, i.e., the preceding data has been processed; otherwise it waits for the data to be processed.

Data processing synchronization and control may be performed according to the related art via a hardwired state machine (see PACT02), a state machine having a fine-grained configuration (see PACT01, PACT04) or, preferably, via a programmable sequencer (PACT13). The programmable state machine is configured according to the sequence to be executed. Altera's EPS448 module (ALTERA Data Book 1993) implements such a programmable sequencer, for example.

One particular function of handshake protocols for VPUs is the performance of pipeline-type data processing, in which in each cycle data may be processed in each PARE in particular. This requirement results in particular demands on the operation of the handshakes. The problem and the achievement of this object are shown using the example of a RDY/ACK protocol:

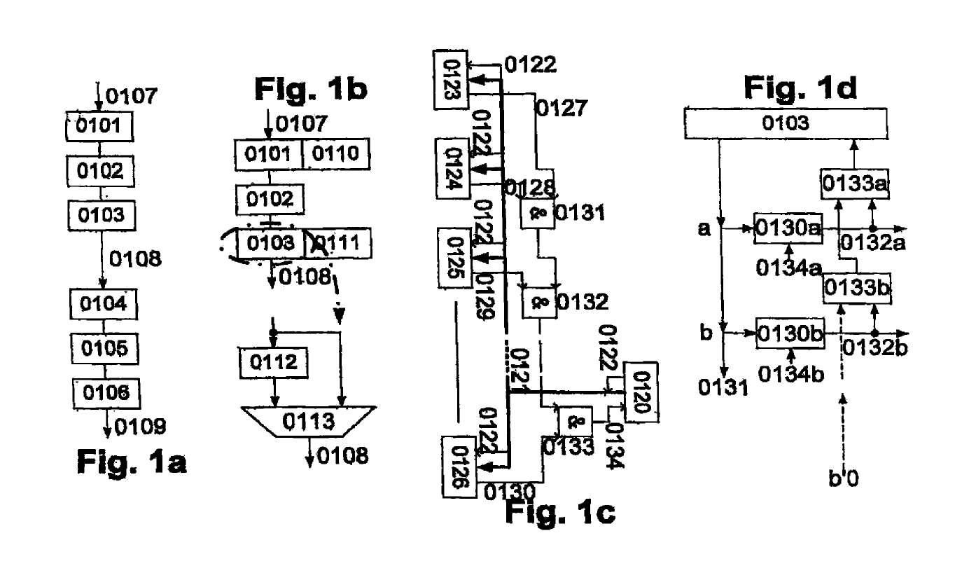

FIG. 1a shows a configuration of a pipeline within a VPU. The data is sent via (preferably configurable) bus systems (0107, 0108, 0109) to registers (0101, 0104), which have an optionally data processing logic (0102, 0105) connected downstream. The logic has an associated output stage (0103, 0106), which preferably also has a register for sending the results to a bus again. The RDY/ACK synchronization protocol is preferably transmitted both via the bus systems (0107, 0108, 0109) and via the data processing logic (0102, 0105).

The two meanings of the terms of the RDY/ACK protocol are as follows:

a) ACK means “receiver will receive data,” having the effect that the pipeline operates in each cycle. However, the problem arises that due to the hard-wiring, in the event of a pipeline stall, the ACK runs asynchronously through all the stopped stages of the pipeline. This results in considerable timing problems, in particular in the case of large VPUs and/or high clock frequencies.

b) ACK means “receiver has received data,” having the effect that the ACK always runs only to the next stage where there is a register. The problem that arises here is that the pipeline only operates in every other cycle due to the delay of the register that is required in the hardwired implementation.

Herein, both meanings are combined as shown in FIG. 1b, which illustrates a section of stages 0101 through 0103. Protocol b) is used on bus systems (0107, 0108, 0109) in that a register (0110) delays the incoming RDY by one cycle by writing the transmitted data into an input register, and relays it again onto the bus as an ACK. This stage (0110) operates almost as a protocol converter between a bus protocol and the protocol within a data processing logic.

The data processing logic uses protocol a), which is generated by a downstream protocol converter (0111). The 0111 unit has the distinguishing feature that a preliminary statement must be made about whether the incoming data from the data processing logic is actually also received by the bus system. This is accomplished by introducing an additional buffer register (0112) in the output stages (0103, 0106) for the data to be transmitted to the bus system. The data generated by the data processing logic is written to the bus system and into the buffer register at the same time. If the bus is unable to receive the data, i.e., no ACK is sent by the bus system, the data is stored in the buffer register and is sent to the bus system via a multiplexer (0113) as soon as the bus system is ready. If the bus system is immediately ready to receive the data, the data is relayed directly to the bus via the multiplexer (0113). The buffer register enables acknowledgment in the meaning a), because acknowledgment may be sent using “receiver will receive data” as long as the buffer register is empty, because writing into the buffer register ensures that the data is not lost.

### Triggers

Triggers, whose operating principles are described in PACT08, are used in VPU modules for transmitting simple information. Triggers are transmitted using a unidimensional or multidimensional bus system divided into segments. The individual segments may be equipped with drivers for improving the signal quality. The particular trigger connections, which are implemented by the interconnection of various segments, are programmed by the user and configured via the CT.

Triggers for example transmit mainly, but not exclusively, the following information or any possible combinations thereof:

Status information of arithmetic units (ALUs), such as
carry
division by zero
zero
negative
underflow/overflow

Results of comparisons and/or loops

n bit information (for small n)

Interrupt requests generated internally or externally.

Triggers are generated by any cells and are activated by any events in the individual cells. In particular, triggers may be generated by a CT or an external unit located outside the cell array or the module.

Triggers are received by any cells and analyzed by any possible method. In particular, triggers may by analyzed by a CT or an external unit located outside the cell array or the module.

Triggers are mainly used for sequence control within a VPU, for example, for comparisons and/or loops. Data paths and/or branchings may be enabled or disabled by triggers.

Another important area of application of triggers is the synchronization and activation of sequences and their information exchange, as well as the control of data processing in the cells.

Triggers may be managed and data processing may be controlled according to the related art by a hardwired state machine (see PACT02, PACT08), a state machine having a fine-grained configuration (see PACT01, PACT04, PACT08), (Chameleon), or preferably by a programmable state machine (PACT13). The programmable state machine is configured in accordance with the sequence to be executed. Altera's EPS448 module (ALTERA Data Book 1993) implements such a programmable sequencer, for example.

### Basic Method

The simple synchronization method using RDY/ACK protocols makes the processing of complex data streams difficult, because observing the correct sequence ties up considerable resources. The correct implementation is the programmer's responsibility. Additional resources are also required for the implementation.

In the following, a simple method for achieving this object is described.

### 1:n Transmission

This case is trivial: The transmitter writes the data onto the bus. The data is stable on the bus until the ACK is received as acknowledgment from all receivers (the data “resides”). RDY is pulsed, i.e., is applied for one cycle to prevent the data from being incorrectly read multiple times. Since RDY activates multiplexers and/or gates and/or other appropriate transmission elements which control the data transfer depending on the implementation, this activation is stored (RdyHold) for the time of the data transmission. This causes the position of gates and/or multiplexers and/or other appropriate transmission elements to remain valid even after the RDY pulse and thus valid data to remain on the bus.

As soon as a receiver has received the data, it acknowledges using an ACK (see PACT02). It should be mentioned again that the correct data remains on the bus until it is received by the receiver(s). ACK is also preferably transmitted as a pulse. If an ACK passes through a multiplexer and/or gate, and/or another appropriate transmission element in which RDY was previously used for storing the activation (see RdyHold), this activation is now cleared.

To transmit 1:n, it may be advisable to hold ACK, i.e., to use no pulsed ACK, until a new RDY is received, i.e., ACK also “resides.” The ACKs received are AND-gated at each bus node representing a branching to a plurality of receivers. Since the ACKs “reside,” a “residing” ACK which represents the ACKs of all receivers remains at the transmitter. In order to keep the running time of the ACK chain through the AND gate as low as possible, it is recommended that a tree-shaped configuration be chosen or generated during the routing of the program to be executed.

Residing ACKs may cause, depending on the implementation, the problem that RDY signals for which there was actually no ACK are ACK-ed because an old ACK resided for too long. One way of avoiding this problem is to basically pulse ACK and to store the incoming ACK of each branch at a branching. An ACK pulse is not relayed toward the transmitter and all stored ACKs (AckHold) and possibly the RdyHolds are not cleared until the ACKs of all branches have been received.

FIG. 1c shows the principle of the example method. A transmitter 0120 transmits data via a bus system 0121 together with a RDY 0122. A plurality of receivers (0123, 0124, 0125, 0126) receive the data and the particular RDY (0122). Each receiver generates an ACK (0127, 0128, 0129, 0130), which are gated via an appropriate boolean logic (0131, 0132, 0133), for example a logical AND function, and sent to the transmitter (0134).

FIG. 1d shows one possible example embodiment having two receivers (a, b). An output stage (0103) transmits data and the associated (in this case pulsed) RDY (0131). RdyHold stages (0130) upstream from the target PAEs translate the pulsed RDY into a residing RDY. In this example, a residing RDY should have the boolean value b′1. The contents of all RdyHold stages are returned to 0103 via a chain of logical OR functions (0133). If a target PAE acknowledges the receipt of data, the corresponding RdyHold stage is only reset by the incoming ACK (0134). Thus, the meaning of the returned signal is b′1=“some PAE or other has not received the data.” As soon as all RdyHold stages have been reset, the information b′0=“all PAEs have received the data” is received by 0103 via the OR chain (0133), which is evaluated as ACK. The outputs (0132) of the RdyHold stages may also be used for activating bus switches as described previously.

A logical b′0 is supplied to the last input of an OR chain to ensure proper operation of the chain.

### n:1 Transmission

This case is relatively complex. (F1) On the one hand, a plurality of transmitters must be multiplexed onto one receiver; (F2) on the other hand, the time sequence of the transmissions must generally be observed. In the following, several methods are described to achieve this object. It should be pointed out that in principle no method is to be preferred. Rather, the most suitable method should be selected according to the system and the algorithms to be executed from the point of view of programmability, complexity, and cost.

A simple n:1 transmission may be implemented by connecting a plurality of data paths to the inputs of each PAE. The PAEs are configured as multiplexer stages. Incoming triggers control the multiplexer and select one of the plurality of data paths. If necessary, tree structures may be constructed from PAEs configured as multiplexers to merge a plurality of data streams (large n). The example method requires special attention on the programmer's part to ensure correct chronological sorting of the different data streams. In particular, all data paths should have the same length and/or delay to ensure the correct sequence of the data.

Other effective methods for merging are described below: Since F1 seems to be easily implementable using any arbiter and a downstream multiplexer, the discussion begins with F2.

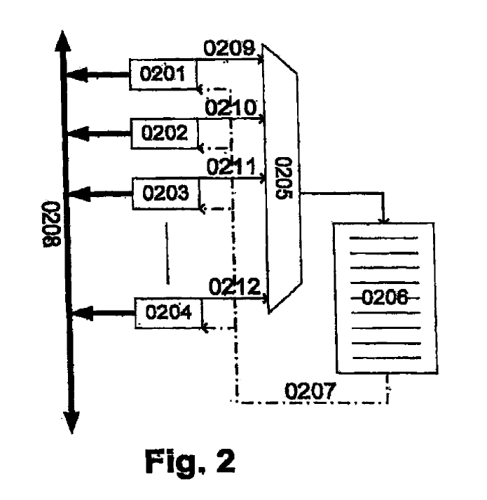

The time sequence cannot be observed using simple arbiters. FIG. 2 shows a first possible example of implementation. A FIFO (0206) is used to store on a bus system (0208) and execute the time sequences of transmission requests correctly. For this purpose, a unique number representing its address is assigned to each transmitter (0201, 0202, 0203, 0204). Each transmitter requests a data transmission to bus system 0208 by displaying its address on a bus (0209, 0210, 0211, 0212). The particular addresses are stored in a FIFO (0206) via a multiplexer (0205) according to the sequence of the transmission requests. The FIFO is executed step-by-step, and the address of the particular FIFO entry is displayed on another bus (0207). This bus addresses the transmitters and the transmitter having the corresponding address receives access to bus 0208. The internal memories of the VPU technology may be used, for example, as FIFO for such a procedure (see PACT04, PACT13).

However, on closer examination, the following problem may arise: as soon as a plurality of transmitters wish to access the bus, one transmitter must be selected whose address is then stored in the FIFO. In the next cycle, the next transmitter is then selected, and so forth. The selection may take place via an arbiter (0205). This eliminates the simultaneity, which however generally represents no problem. For real time applications, a prioritizing arbiter might be used. The method, however, fails because of this simple reason: At time t, three transmitters S1, S2, S3 request receiver E. S1 is stored at t, S2 is stored at t+1, and S3 is stored at t+2. However, at t+1 S4 and S5, at t+2 also S6 and again S1 request the receiver. Because the new requests overlap with the old ones, processing very quickly becomes extremely complex and requires considerable additional hardware resources.

Thus, the example method shown in FIG. 2 may be used for simple n:1, which, if possible, have no simultaneous bus requests.

According to this discussion, it may be advisable not to store one transmitter per cycle, but the set of all transmitters that request the transmission in a given cycle. In the following cycle, the new set is then stored. If several transmitters request the transmission in the same cycle, these are arbitrated at the time the memory is processed.

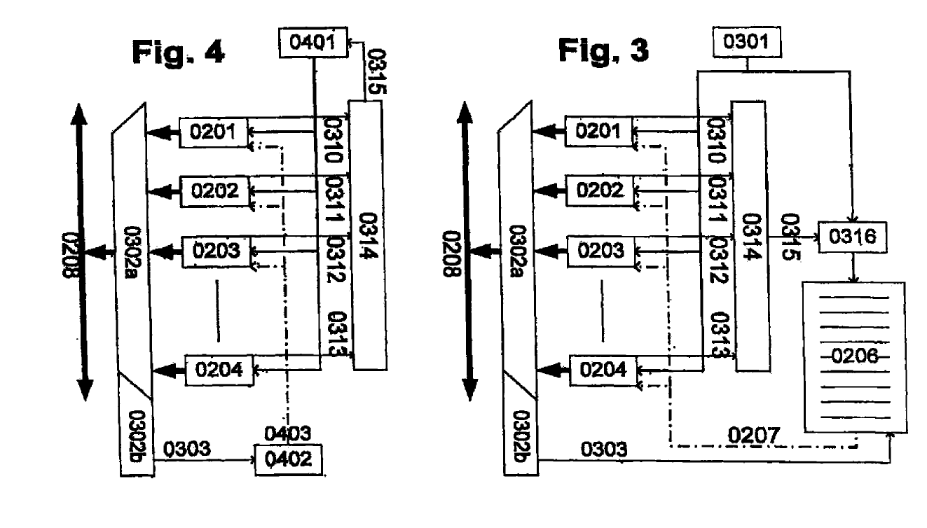

Storing a plurality of transmitter addresses at the same time may be very complicated. A simple implementation is achieved by the following example embodiment in FIG. 3:
An additional counter (REQCNT, 0301) counts the number of cycles T. Each transmitter (0201, 0202, 0203, 0204) which requests the transmission at cycle t stores the value of REQCNT (REQCNT(t)) at cycle t as its address.
Each transmitter which requests the transmission at cycle t+1 stores the value of REQCNT (REQCNT(t+1)) at cycle t+1 as its address.
. . .
Each transmitter which requests the transmission at cycle t+n stores the value of REQCNT (REQCNT(t+n)) at cycle t+n as its address.

The FIFO (0206) stores the values of REQCNT(tb) at a given cycle tb.

The FIFO displays a stored value of REQCNT as a transmission request on a separate bus (0207). Each transmitter compares this value with the one it has stored. If the values are identical, it transmits the data. If a plurality of transmitters have the same value, i.e., simultaneously wish to transmit data, the transmission is now arbitrated by a suitable arbiter (CHNARB, 0302b) and sent to the bus by a multiplexer (0302a) activated by the arbiter. A possible exemplary embodiment of the arbiter is described in the following.

If no transmitter responds to a REQCNT value, i.e., the arbiter has no more bus requests for arbitration (0303), the FIFO switches to the next value. If the FIFO has no more valid entries (empty), the values are identified as invalid to prevent erroneous bus access.

In a preferred embodiment, only those values of REQCNT are stored in the FIFO (0206) for which there was a bus request of a transmitter (0201, 0202, 0203, 0204). For this purpose, each transmitter signals its bus request (0310, 0311, 0312, 0313), which are logic gated (0314), e.g., by an OR function. The resulting transmission request of all transmitters (0315) is supplied to a gate (0316) which supplies only those REQCNT values to the FIFO (0206) at which there was an actual bus request.

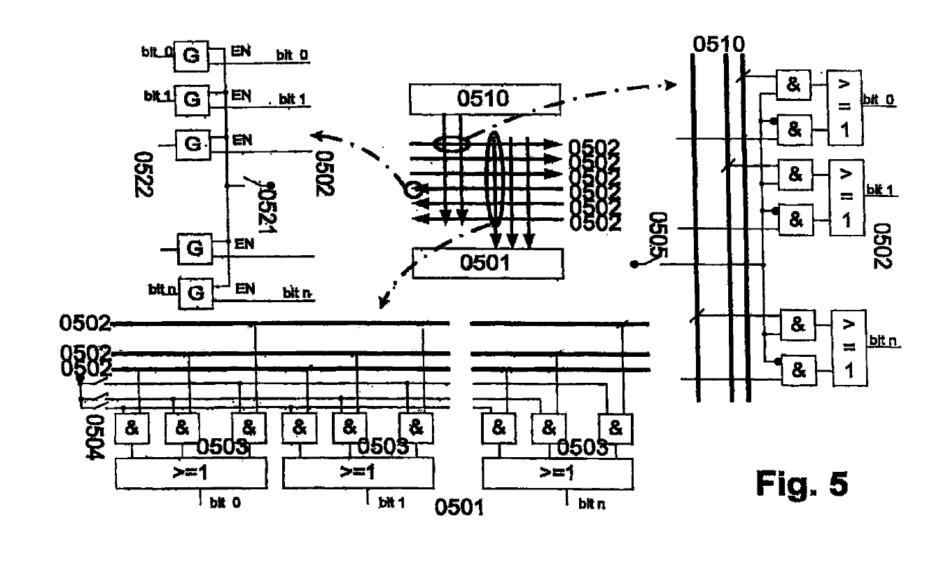

The above-described procedure may be further optimized according to an example embodiment corresponding to FIG. 4 as follows: A linear sequence of values (REQCNT(tb)) is generated by REQCNT (0410) if, instead of all cycles t, only those cycles are counted in which there is a bus request by a transmitter (0315). The FIFO is now replaceable by a simple counter (SNDCNT, 0402), which now also counts linearly and whose value (0403) enables the particular transmitters according to 0207, due to the linear sequence of values, generated by REQCNT, which now has no gaps. SNDCNT continues to increment as long as no transmitter responds to the value from SNDCNT. As soon as the value of REQCNT is identical to the value of SNDCNT, SNDCNT stops counting, since the last value has been reached.

It is true for all implementations that the maximum required width of REQCNT is equal to log₂(number_of_transmitters). When the largest possible value is exceeded, REQCNT and SNDCNT restart at the minimum value (usually 0).

### Arbiters

A plurality of arbiters may be used as CHNARB according to the related art. Depending on the application, prioritized or unprioritized arbiters may be better suited, prioritized arbiters having the advantage that they are able to give preference to certain tasks for real time tasks.

A serial arbiter, which is implementable in the VPU technology in a particularly simple and resource-saving manner, is described in the following. In addition, the arbiter offers the advantage of working in a prioritizing mode, which permits preferred processing of certain transmissions.

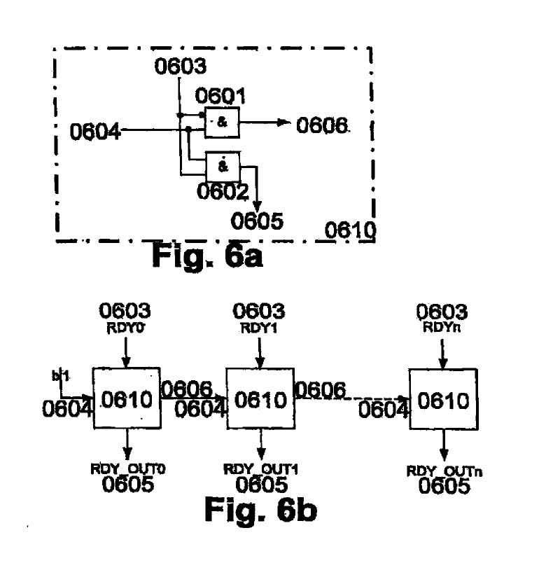

A possible basic configuration of a bus system is initially described in FIG. 5. Modules of the generic VPU type have a network of parallel data bus systems (0502), each PAE having connection to at least one data bus for data transmission. A network is usually made up of a plurality of equivalent parallel data buses (0502); each data bus may be configured for one data transmission. The remaining data buses may be freely available for other data transmissions.

It should be furthermore mentioned that the data buses may be segmented, i.e., using configuration (0521) a bus segment (0502) may be switched through to the adjacent bus segment (0522) via gates (G). The gates (G) may be made up of transmission gates and preferably have signal amplifiers and/or registers.

A PAE (0501) preferably picks up data from one of the buses (0502) via multiplexers (0503) or a comparable circuit. The enabling of the multiplex system is configurable (0504).

The data (results) generated by a PAE are preferably supplied to a bus (0502) via a similar independently configurable (0505) multiplexer circuit.

The circuit described in FIG. 5 is labeled using bus nodes.

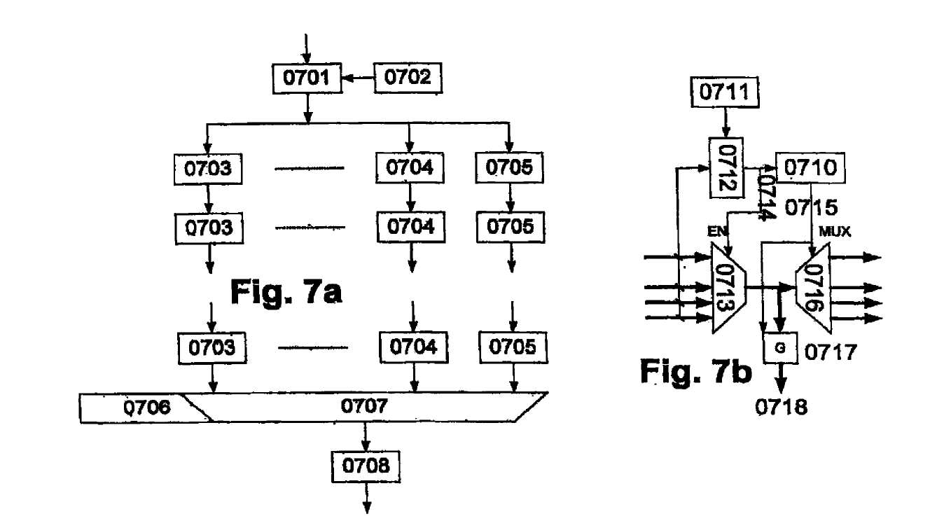

A simple arbiter for a bus node may be implemented as illustrated in FIG. 6 as follows:

Basic element 0610 of a simple serial arbiter may be made up by two AND gates (0601, 0602), FIG. 6a. The basic element has an input (RDY, 0603) through which an input bus shows that it is transmitting data and requesting an enable to the receiver bus. Another input (ACTIVATE, 0604) which in this example shows via a logical 1 level, that none of the preceding basic elements has currently arbitrated the bus and therefore arbitration by this basic element is allowed. Output RDY_OUT (0605) shows, for example, to a downstream bus node that the basic element has enabled the bus access (if there is a bus request (RDY)) and ACTIVATE_OUT (0606) shows that the basic element is not currently performing any (more) enabling because no bus request (RDY) exists (any longer) and/or no previous arbiter stage has occupied the receiver bus (ACTIVE).

A serial prioritizing arbiter is obtained by the serial chaining of ACTIVATE and ACTIVATE_OUT via basic elements 0610, the first basic element according to FIG. 6b, whose ACTIVATE input is always activated, having the highest priority.

The above-described protocol ensures that within the same SNDCNT value each PAE only performs one data transmission, because a subsequent data transmission would have another SNDCNT value. This condition is required for proper operation of the serial arbiter, because this ensures the processing sequence of the enable requests (RDY) necessary for prioritization. In other words, an enable request (RDY) cannot appear later during an arbitration on the basic elements which already show, via ACTIVATE_OUT, that they enable no bus access.

### Locality and Running Time

The example method is applicable, in principle, over long paths. Beyond a length depending on the system frequency, transmission of the data and execution of the protocol are no longer possible in a single cycle.

One approach is to design the data paths to be of exactly the same length and merge them at one point. This makes all control signals for the protocol local, which makes it possible to increase the system frequency. To balance the data paths, FIFO stages may be used, which operate as delay lines having configurable delays. They will be described in more detail below.

A very advantageous approach in which data paths may also be merged in a tree shape may be constructed as follows:

### Modified Protocol, Time Stamp

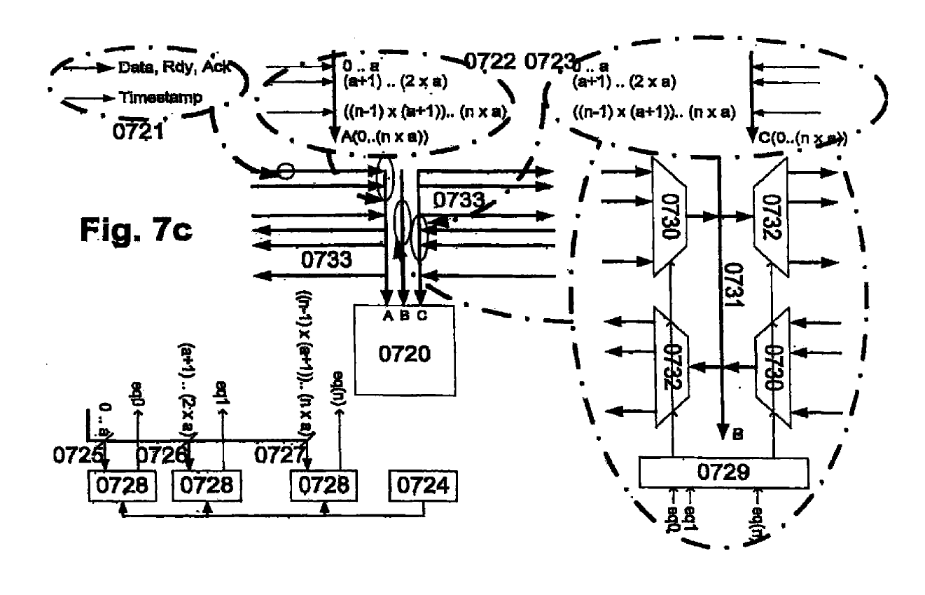

The prerequisite is that a data path be divided into a plurality of branches and re-merged later. This is usually accomplished at branching points such as programmer-constructed “IF” or “CASE” nodes; FIG. 7a shows a CASE-like configuration as an example.

A REQCNT (0702) is assigned to the last PAE upstream from a branching (0701), at the latest; REQCNT assigns a value (time stamp), which is then to be always transmitted together with the data word, to each data word. REGCNT increments linearly with each data word, so that the position of a data word within a data stream is determinable via a unique value. The data words subsequently branch off into different data paths (0703, 0704, 0705). The associated value (time stamp) is transmitted via the data paths with each data word.

A multiplexer (0707) re-sorts the data words into the correct sequence upstream from the PAE(s) (0708) which further process the merged data path. For this purpose, a linearly counting SNDCNT (0706) is associated with the multiplexer. The value (time stamp) assigned to each data word is compared to the value of SNDCNT. The multiplexer selects the matching data word. If no matching data word is found at a certain point in time, no selection is made. SNDCNT increments only if a matching data word has been selected.

To achieve maximum clock frequency, the data paths are merged locally to the highest possible degree. This minimizes the conductor lengths and keeps the associated run times short.

If necessary, the data path lengths are to be adjusted via register stages (pipelines) until it is possible to merge all data paths at a common point. Attention should be paid to making the lengths of the pipelines approximately the same to prevent excessive time shifts between the data words.

### Use of the Time Stamp for Multiplexing

The output of a PAE (PAE-S) is connected to a plurality of PAEs (PAE-E). Only one of the PAEs should process the data in each cycle. Each PAE-E has a different hard-wired address, which is compared with the TimeStamp bus. The PAE-S selects the receiving PAE by outputting the address of the receiving PAE to the TimeStamp bus. In this way the PAE for which the data is intended is addressed.

### Predictive Design and Task Switch

The problem of predictive design is known from conventional microprocessors. It occurs when the data processing depends on a result of the preceding data processing; however, processing of the dependent data is begun in advance—without the required results being available—for reasons of performance. If the result is different from what has been assumed, the data based on erroneous assumptions must be reprocessed (misprediction). This may also occur in VPUs in general.

By re-sorting and similar procedures this problem may be minimized; however, its occurrence may never be ruled out.

A similar problem occurs when the data processing is aborted, before it has been completed, due to a unit (such as the task scheduler of an operating system, real-time request, etc.) of a higher level than data processing within the PAs. In this case, the status of the pipeline must be saved so that the data processing resumes downstream from the point of the operands that resulted in the computation of the last finished result.

Two relevant states occur in a pipeline:
RD At the beginning of a pipeline, the reception or request of new data is displayed;
DONE At the end of a pipeline, the correct processing of data for which no misprediction occurred is displayed.

Furthermore, the MISS_PREDICT state may be used, which shows that a misprediction occurred. It may be helpful to generate this status by negating the DONE status at the appropriate point in time.

### Special FIFOs

PACT04 and PACT13 describe methods in which data is kept in memories from which it is read for processing and in which results are stored. For this purpose, a plurality of independent memories may be used, which may operate in different operating modes; in particular, direct access, stack mode, or FIFO operating mode may be used.

Data is normally processed linearly in VPUs, so that the FIFO operating mode is often preferentially used. For example, a special extension of the memories should be considered for the FIFO operating mode, which directly supports prediction and enables reprocessing of mispredicted data in the event of misprediction. Furthermore, the FIFO supports task switches at any point in time.

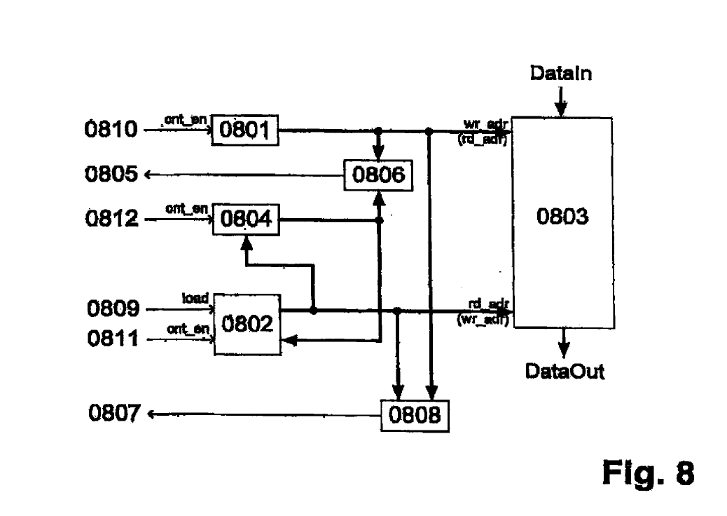

We shall initially discuss the extended FIFO operating modes using the example of a memory providing read access (read side) within a given data processing run. The exemplary FIFO is illustrated in FIG. 8.

The configuration of the write circuit having a conventional write pointer (WR_PTR, 0801) which advances with each write access (0810) corresponds to the related art. The read circuit has the conventional counter (RD_PTR, 0802), for example, which counts each read word according to a read signal (0811) and modifies the read address of the memory (0803) accordingly. Novel, with respect to the related art, is an additional circuit (DONE_PTR, 0804), which does not document the data which has been read out, but the data which has been read out and correctly processed; in other words, only the data where no error has occurred and whose result was output at the end of the computation and a signal (0812) was displayed as a sign of the correct end of the computation. Possible circuits are described in the following.

The FULL flag (0805) (according to the related art), which shows that the FIFO is full and unable to store additional data, is now generated by a comparison (0806) of DONE_PTR with WR_PTR which ensures that data which may have to be reused due to a possible misprediction is not overwritten.

The EMPTY flag (0807) is generated, according to the conventional configuration, by comparison (0808) of RD_PTR with the WR_PTR. If a misprediction (MISS_PREDICT, 0809) occurred, the read pointer is loaded with the value DONE_PTR+1. Data processing is thus restarted at the value that triggered the misprediction.

Two possible exemplary configurations of DONE_PTR should be discussed in more detail.

### a) Implementation by a Counter

DONE_PTR is implemented as a counter, which is set equal to RD_PTR when the circuit is reset or at the beginning of a data processing run. An incoming signal (DONE) indicates that the data has been processed successfully (i.e., without misprediction). DONE_PTR is then modified so that it points to the next data word being processed.

### b) Implementation by a Subtractor

As long as the length of the data processing pipeline is always exactly known and it is assured that the length is constant (i.e., no branching into pipelines of different lengths occurs), a subtractor may be used. The length of the pipeline from when the memory is connected to the recognition of a possible misprediction is stored in an associated register. After a misprediction, data processing must therefore be reinitialized at the data word which may be computed via the difference.

On the write side, in order to save the result of the data processing of a configuration, an appropriately configured memory is required, the function of DONE_PTR being implemented for the write pointer to overwrite (mis)computed results during a new data processing run. In other words, the functions of the read/write pointer are reversed according to the addresses in brackets in the drawing.

If data processing is interrupted by another source (e.g., task switch of an operating system), it is sufficient to save DONE_PTR and to reinitialize the data processing at a later point in time at DONE_PTR+1.

### FIFOs for Input/Output Stages, e.g., 0101, 0103

In order to balance data paths and/or states of different edges of a graph or different branches of a data processing run (trigger, see PACT08, PACT13), it is useful to use configurable FIFOs at the outputs or inputs of the PAEs. The FIFOs have adjustable latencies, so that the delay of different edges/branches, i.e., the run times of data over different but usually parallel data paths, are adjustable to one another.

As a pipeline may be held up within a VPU by pending data or a pending trigger, the FIFOs are also useful for compensating such delays. The FIFOs described in the following accomplish both functions:

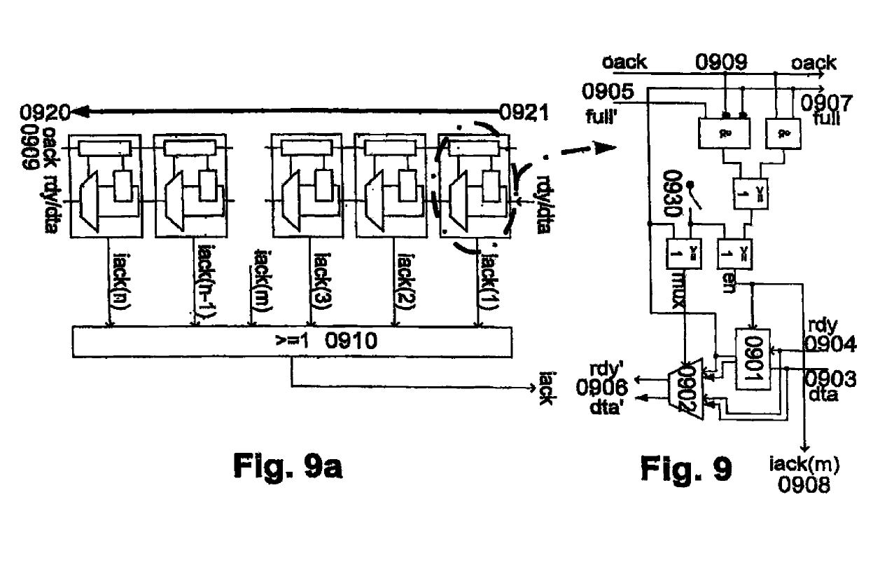

A FIFO stage may be configured, for example, as follows (see FIG. 9): A multiplexer (0902) is connected downstream from a register (0901). The register stores the data (0903) and also its correct existence, i.e., the associated RDY (0904). Data is written into the register when the adjacent FIFO stage which is situated closer to the FIFO output (0920) indicates that it is full 0905) and a RDY (0904) exists for the data. The multiplexer relays the incoming data (0903) directly to the output (0906) until the data has been written into the register and thus the FIFO stage itself is full, which is indicated (0907) to the adjacent FIFO stage, which is situated closer to the input (0921) of the FIFO. Receipt of data in a FIFO stage is acknowledged with an input acknowledge (IACK, 0908). The output of data from a FIFO is acknowledged by an output acknowledge (OACK, 0909). OACK reaches all FIFO stages at the same time and causes the data to be shifted forward in the FIFO by one stage.

Individual FIFO stages may be cascaded to form FIFOs of any desired length (FIG. 9a). For this purpose, all IACK outputs are logically gated with one another, for example, by an OR function (0910).

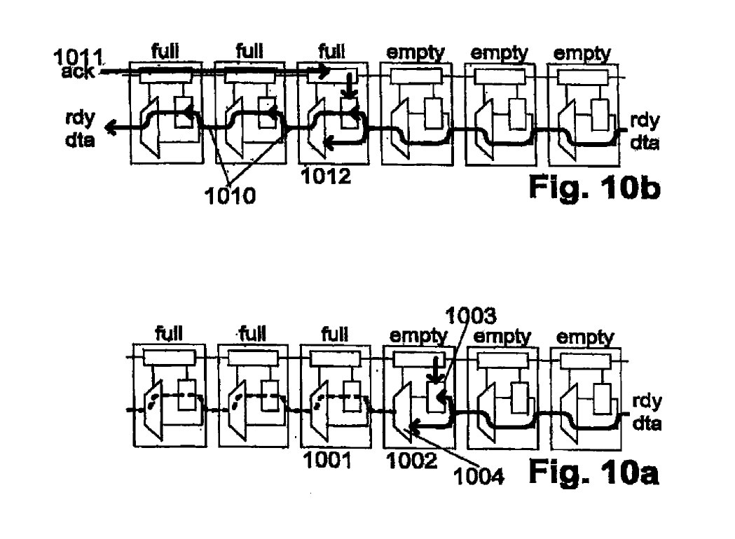

The mode of operation is elucidated using the example of FIG. 10.a, b.

### Appending a Data Word

A new data word is passed on via the multiplexers of the individual FIFO stages to the registers. The first full FIFO stage (1001) signals to the upstream stage (1002), using the stored RDY, that it cannot receive data. The upstream stage (1002) has no RDY stored, but is aware of the “full” status of the downstream stage (1001). Therefore the stage stores the data and the RDY (1003) and acknowledges the storage by an ACK to the transmitter. The multiplexer (1004) of the FIFO stage switches over in such a way that, instead of the data path, it relays the contents of the register to the downstream stage.

### Removing a Data Word

If an ACK (1011) is received by the last FIFO stage, the data of each upstream stage is transmitted to the particular downstream stage (1010). This is accomplished by applying a global write cycle to each stage. Because all multiplexers are already set according to the register contents, all data slips one line downward in the FIFO.

### Removing and Simultaneously Appending a Data Word

If the global write cycle has been applied, no data word is stored in the first free stage. Because the multiplexer of this stage still forwards the data to the downstream stage, the first full stage (1012) stores the data. Its data is stored by the downstream stage in the same cycle as described above. In other words: new data to be written automatically slips into the now first free FIFO stage (1012), i.e., the previously last full FIFO stage, which has been emptied by the arrival of ACK.

### Configurable Pipeline

For certain applications it may be advantageous to switch, using a switch (0930), individual multiplexers of the FIFO in the FIFO stage shown in FIG. 9 as an example in such a way that basically the corresponding register is switched on. A fixed settable latency or delay time is thus configurable via the switch for the data transmission.

### Merging Data Streams

Three methods are available for merging data streams, each being best suited to particular applications:

a) local merge,
b) tree merge,
c) memory merge.

### Local Merge

Local merge is the simplest variant, where all data streams are preferably merged at a single point or relatively locally and immediately split again if appropriate. A local SNDCNT selects, via a multiplexer, the exact data word whose time stamp corresponds to the value of SNDCNT and therefore is now expected. Two options are explained in more detail on the basis of FIGS. 7a and 7b.

a) A counter SNDCNT (0706) is incremented for each incoming data packet. A comparator which compares the particular count with the time stamp of the data path is connected downstream in each data path. If the values coincide, the current data packet is relayed to the downstream PAEs via the multiplexer.

b) The approach of a) is extended by assigning a target data path to the currently active data path, preferably via a translation procedure, for example, a CT configurable lookup table (0710), after the selection of this data path as the source data path. The source data path is determined by comparing (0712) the time stamp arriving with the data according to method a) with a SNDCNT (0711), the coinciding data path is addressed (0714) and selected via a multiplexer (0713). Using the lookup table (0710), for example, the address (0714) is assigned to a target data path address (0715), which selects the target path via a demultiplexer (0716). If the above-described structure is implemented in bus nodes as in FIG. 7b, the data link of the PAE (0718) associated with the bus node may also be established via the exemplary lookup table (0710), for example, via a gate function (transmission gates) (0717) to the input of the PAE.

A particularly effective exemplary circuit is illustrated in FIG. 7c. A PAE (0720) has three data inputs (A, B, C) as in the XPU128ES, for example. The bus system (0733) connections to the data inputs, for example, may be configurable and/or multiplexable, and selectable for each clock cycle. Each bus system transmits data, handshakes, and the associated time stamp (0721). Inputs A and C of the PAE (0720) are used for relaying the time stamp of the data channels to the PAE (0722, 0723). The individual time stamps may be bundled by the SIMD bus system described in the following, for example. The bundled time stamps are unbundled again in the PAE and each time stamp (0725, 0726, 0727) is individually compared (0728) to an SNDCNT (0724) implemented/configured in the PAE. The results of the comparisons are used for activating the input multiplexers (0730) in such a way that the bus system is connected to a bus (0731) using the correct time stamp. The bus is preferably connected to input B to permit data to be relayed to the PAE according to 0717, 0718. The output demultiplexers (0732) for relaying the data to different bus Systems are also activated by the results, the results being preferably re-sorted by a flexible translation, for example, by a lookup table (0729), to enable the results to be freely assigned to selecting bus systems via demultiplexers (0732).

### Tree Merge

In many applications it is desirable to merge parts of a data stream at a plurality of points, which results in a tree-like structure. The problem is that it is impossible to make a central decision on the selection of a data word, but the decision is distributed over multiple nodes. Therefore, the particular value of SNDCNT must be transferred to all nodes. However, in the case of high clock frequencies, this is only accomplishable with a latency, which occurs, for example, due to a plurality of register stages during the transmission. Therefore, this approach initially yields no reasonable performance.

A method for improving the performance is allowing local decisions to be made in each node, independently of the value of SNDCNT. A simple approach, for example, is to select the data word with the smallest time stamp at a node. This approach, however, becomes problematic if a data path delivers no data word to a node during a cycle. Then it may be impossible to decide which data path is to be preferred.

The following algorithm improves on this situation:
a) Each node receives a standalone SNDCNT counter SNDCNT_{K}.
b) Each node should have n input data paths (P₀, . . . Pₙ).
c) Each node may have a plurality of output data paths, which are selected via a translation procedure, for example, a lookup table which is configurable by a higher-level configuration unit CT, depending on the input data path.
d) The root node has a main SNDCNT to which all SNDCNT_{K} are synchronized if appropriate.

The following algorithm is used to select the correct data path:

I. If data appears on all input data paths Pₙ:
a) select the data path P_{(Ts)} having the smallest time stamp Ts.
b) assign K:=Ts+1; SNDCNT>Ts+1, then SNDCNT_{K}:=SNDCNT.

II. If data does not appear on all input data paths Pn:
a) select a data path only if the time stamp Ts==SNDCNT_{K}.
b) SNDCNT_{K}:=SNDCNT+1.
c) SNDCNT:=SNDCNT+1.

III. If no assignment takes place in a cycle, then:
a) SNDCNT_{K}:=SNDCNT.

IV. The root node has the SNDCNT which is incremented for each selection of a valid data word and ensures the correct sequence of the data words at the root of the tree. All other nodes are synchronized to the value of SNDCNT if necessary (see 1-3). There is a latency which corresponds to the number of registers, which must be introduced for bridging the segment from SNDCNT to SNDCNT_{K}.

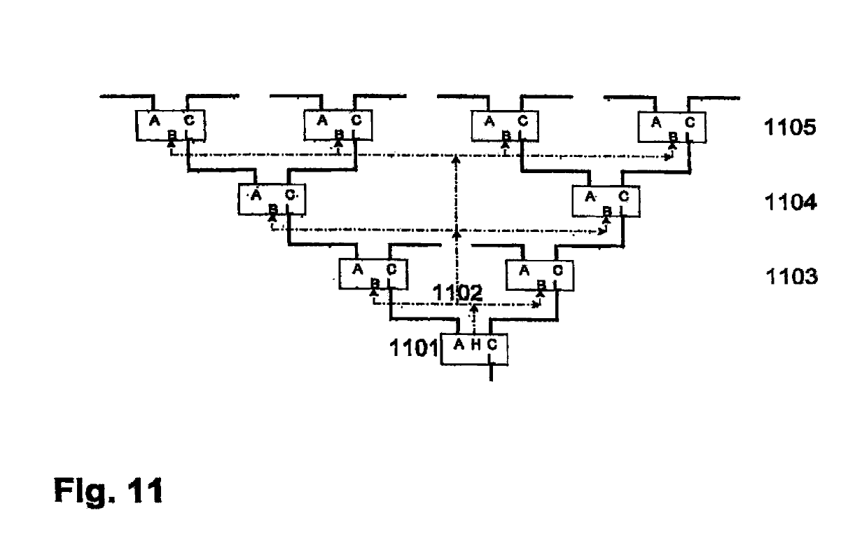

FIG. 11 shows a possible tree, which is constructed, for example, of PAEs in a manner similar to those of the XPU128ES VPU. A root node (1101) has an integrated SNDCNT, whose value is available at output H (1102). The data words at inputs A and C are selected according to the above-described procedure and the particular data word is supplied to output L in the correct sequence.

The PAEs of the next hierarchical level (1103) and on each additional higher hierarchical level (1104, 1105) work similarly, but with the following difference: The integrated SNDCNT_{K} is local, and the particular value is not forwarded. SNDCNT_{K} is synchronized with SNDCNT, whose value is applied to input B, according to the above-described procedure.

SNDCNT may be pipelined between all nodes, however, in particular between the individual hierarchical levels, for example, via registers.

### Memory Merge

In this procedure, memories are used for merging data streams. A memory location is assigned to each value of the time stamp. The data is then stored in the memory according to the value of its time stamp; in other words, the time stamp is used as the address of the memory location for the assigned data. This creates a data space which is linear to the time stamp, i.e., is sorted according to the time stamp. The memory is not enabled for further processing, i.e., read out linearly, until the data space is complete, i.e., all the data is stored. This is easily determinable, for example, by counting how many pieces of data have been written into a memory. If as many pieces of data have been written as the memory has data entries, it is full.

The following problem arises during the execution of the basic principle: Before the memory is filled without any gap, a time stamp overrun may occur. An overrun is defined as follows: A time stamp is a number from a finite linear arithmetic space (TSR). The time stamp is specified strictly monotonously, whereby each specified time stamp is unique within the TSR arithmetic space. If the end of the arithmetic space is reached when a time stamp is specified, the specification is continued from the beginning of TSR; this results in a point of discontinuity. The time stamps specified now are no longer unique with respect to the preceding ones. It must always be ensured that these points of discontinuity are taken into account during processing. The arithmetic space (TSR) must therefore be selected to be sufficiently large for no ambiguity to be created in the most unfavorable case by two identical time stamps occurring within the data processing. In other words, the TSR must be sufficiently large for no identical time stamps to exist within the processing pipelines and/or memories in the most unfavorable case which may occur within the subsequent processing pipelines and/or memories.

If a time stamp overrun occurs, the memories must always be able to respond to such overrun. It must therefore be assumed that, after an overrun, the memories will contain both data having the time stamp before the overrun (“old data”) and data having the time stamp after the overrun (“new data”).

The new data cannot be written into the memory locations of the old data, since they have not yet been read out. Therefore several (at least two) independent memory blocks are provided, so that the old and new data may be written separately.

Any method may be used to manage the memory blocks. Two example options are discussed in more detail:
a) If it is always ensured that the old data of a given time stamp value is received before the new data of this time stamp value, it is tested whether the memory location for the old data is still free. If this is the case, old data is present, and the data is written to the memory location; if not, new data is being applied, and the data is written to the memory location for the new data.
b) If it is not ensured that the old data of a given time stamp value is received before the new data of this time stamp value, the time stamp may be provided with an identifier which differentiates the old time stamp from the new time stamp. This identifier may be one or more bits long. In the event of time stamp overrun, the identifier is linearly modified. In this way, old and new data is provided with unique time stamps. The data is assigned to one of the multiple data blocks according to the identifier.

Identifiers whose maximum numerical value is considerably less than the maximum numerical value of the time stamps are preferably used. A preferred ratio may be given by the following formula:

identifierₘₐₓ<time stampₘₐₓ/2.

### Use of Memories for Partitioning Wide Graphs

As described in from PACT13, large algorithms should be partitioned, i.e., divided into a plurality of partial algorithms so that they fit a given arrangement and number of PAEs of a VPU. The partitioning should be performed both efficiently with respect to performance and naturally, while preserving the correctness of the algorithm. One aspect is the management of data and states (triggers) of the particular data paths. In the following, methods are presented for improved and simplified management.

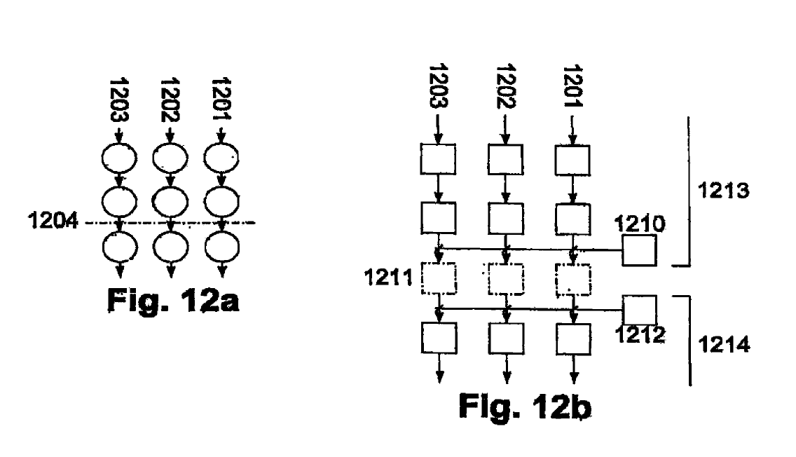

In many cases it is not possible to section a data flow graph at one edge only (see FIG. 12a for example), because the graph is too wide, for example, or there are too many edges (1201, 1202, 1203) at the section point (1204).

Partitioning may be performed according to an example embodiment of the present invention by sectioning along all edges according to FIG. 12b. The data of each edge of a first configuration (1213) is written into a separate memory (1211).

It should be pointed out that, together with (or possibly also separately from) the data, all relevant status information of the data processing also runs over the edges (for example, in FIG. 12b) and may be written into the memories. The status information is represented in VPU technology by triggers (see, e.g., PACT08), for example.

After reconfiguration, the data and/or status information of a subsequent configuration (1214) is read out from the memories and processed further by this configuration.

The memories work as data receivers of the first configuration (i.e., in a mainly write mode) and as data transmitters of the subsequent configuration (i.e., in a mainly read mode). The memories (1211) themselves are a part/resource of both configurations.

To correctly process the data further, it is necessary to know the correct chronological sequence in which the data was written into the memories.

Basically this may be ensured by
a) sorting the data streams when writing into a memory, and/or
b) sorting the data streams when reading out from a memory, and/or
c) saving the sorting sequence with the data and making it available to the subsequent data processing.

For this purpose, control units which are responsible for managing the data sequences and data relationships both when writing the data (1210) into the memories (1211) and when reading out the data from the memories (1212) are assigned to the memories. Depending on the configuration, different management modes and corresponding control mechanisms may be used.

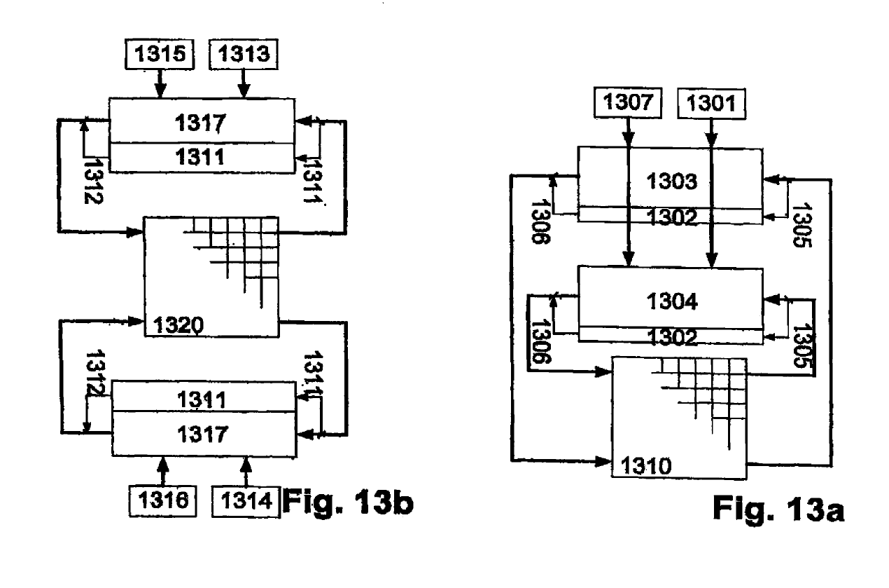

Two possible corresponding methods should be elucidated in more detail with reference to FIG. 13. The memories are assigned to an array (1310, 1320) of PAEs, in a manner similar to the data processing method described in PACT04.

a) In FIG. 13a, the memories generate their addresses synchronously, for example, by common address generators, which are independent but synchronized. In other words, the write address (1301) is incremented in each cycle regardless of whether a memory actually has valid data to be stored. Thus, a plurality of memories (1303, 1304) have the same time base, i.e., write/read address. An additional flag (VOID, 1302) for each data memory position in the memory indicates whether valid data has been written into a memory address. The VOID flag may be generated by the RDY flag (1305) assigned to the data; accordingly, when reading out a memory, the data RDY flag (1306) is generated from the VOID flag. For reading out the data by the subsequent configuration, a common read address (1307), which is advanced in each cycle, is generated similarly to the writing of the data.

b) In the example of FIG. 13b it is more efficient to assign a time stamp to each data word according to the previously described method. The data (1317) is stored with the particular time stamp (1311) in the particular memory position. Thus, no gaps are formed in the memories, which are more efficiently utilized Each memory has independent write pointers (1313, 1314) for the data-writing configuration and read pointers (1315, 1316) for the subsequent data-reading configuration. According to a conventional method (e.g., according to FIG. 7a or FIG. 11), the chronologically correct data word is selected when reading on the basis of the associated time stamp stored (1312) with it.

The data may also be sorted into the memories/from the memories according to different algorithmically suitable methods such as
a) by assigning a memory location using the time stamp;
b) by sorting into the data stream according to the time stamp;
c) by storing in each cycle together with a VALID flag;
d) by storing the time stamp and forwarding it to the subsequent algorithm when reading out the memory.

Depending on the application, a plurality of (or all) data paths may also be merged upstream from the memories via the merge method according to the present invention. Whether this is done generally depends on the available resources. If too few memories are available, merging upstream from the memories is necessary or desirable. If too few PAEs are available, preferably no additional PAEs are used for a merge.

### Extension of the Peripheral Interface (IO) Using Time Stamp

In the following, a method of assigning time stamps to IO channels for peripheral modules and/or external memories is described. The method may serve different purposes such as to allow proper sorting of data streams between transmitter and receiver and/or selecting unique data stream sources and/or targets.

The following discussion will be illustrated using the example of the interface cells from PACT03. PACT03 describes a method of bundling buses internal to the VPU and of data exchange between different VPUs or VPUs and peripherals (IO).

One disadvantage of this method is that the data source is no longer identifiable by the receiver, nor is the correct chronological sequence ensured.

The following novel methods eliminate this problem; some or more of the methods described may be used and possibly combined according to the specific application.

### a) Identification of the Data Source

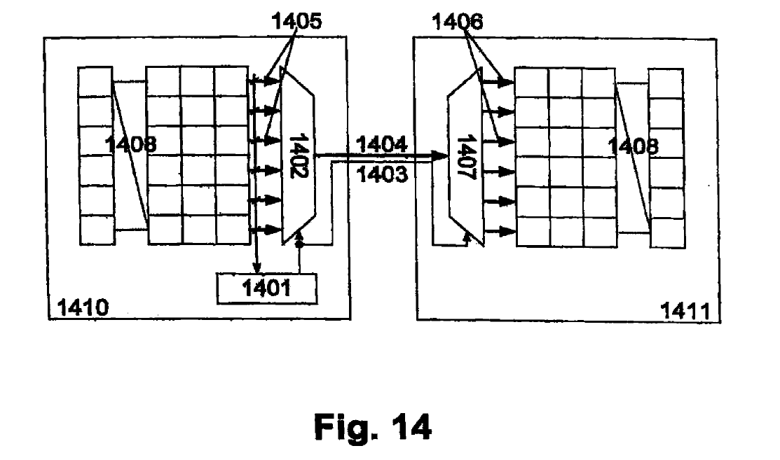

FIG. 14 as an example describes such an identification between arrays (PAs, 1408) made up of reconfigurable elements (PAEs) of two VPUs (1410, 1420). An arbiter (1401) selects on a data transmission module (VPU, 1410) one of the possible data sources (1405) to connect it to the IO via a multiplexer (1402). The address of the data source (1403), together with the data (1404), is sent to the IO. The data-receiving module (VPU, 1411) selects, according to the address (1403) of the data source, the particular receiver (1406) via a demultiplexer (1407). The address transmitted (1403) may be assigned to the receiver (1406) in a flexible manner via a translation procedure, for example, a lookup table which is configurable by a higher-level configuration unit (CT), for example.

It should be expressly pointed out that interface modules connected upstream from the multiplexers (1402) and/or downstream from the demultiplexers (1407) according to PACT03 and/or PACT15 may be used for the configurable connection of bus systems.

b) Compliance with the chronological sequence

b1) The simplest procedure is to send the time stamp to the and to leave the evaluation to the receiver which receives the time stamp.

b2) In another version, the time stamp is decoded by the arbiter which selects only the transmitter having the correct time stamp and sends to the IO. The receiver receives the data in the correct sequence.

Methods a) and b) are usable together or separately depending on the requirements of the particular application.

Furthermore, the method may be extended by specifying and identifying channel numbers. A channel number identifies a given transmitter area. For example, a channel number may be composed of a plurality of IDs, such as that of the bus within a module, the module, and/or the module group. This also makes identification easy, even in applications with a large number of PAEs and/or a combination of several modules.

In using channel numbers, instead of transmitting individual data words, a plurality of data words are preferably combined into a data packet and then transmitted with the specification of the channel number. The individual data words may be combined via a suitable memory such as described in PACT18 (BURST-FIFO), for example.

It should be pointed out that the addresses and/or time stamps which have been transmitted may preferably be used as identifiers or parts of identifiers in bus systems according to PACT15.

The method according to PACT07 is included in its entirety in the present patent, which may also be extended by the above-described identification method. Furthermore, the data transmission methods according to PACT18, for which the above-described method may also be applied, are included in their entirety.

### Sequencer Structure

The use of time stamps or comparable methods makes a simpler structure of sequencers made up of PAE groups possible. The buses and basic functions of the circuit are configured, and the detail function and data addresses are flexibly set via an OpCode at run time.

A plurality of these sequencers may also be constructed and operated within a PA (PAE arrays).

The sequencers within a VPU may be constructed according to the algorithm. Examples have been given in multiple documents of the inventor which are incorporated in the present invention in their entirety. In particular, reference should be made to PACT13, where the construction of sequencers from a plurality of PAEs is described, which is to be also used as an exemplary basis for the description that follows.

In detail, the following configurations of sequencers may be freely adapted, for example:
type and number of IO/memories
type and number of interrupts (e.g., via triggers)
instruction set
number and type of registers.

A simple sequencer may be constructed from, for example,
1. an ALU for performing the arithmetic and logical functions;
2. a memory for storing data, similar to a register set;
3. a memory as a code source for the program (e.g., normal memory according to PACT22/24/13 and/or CT according to PACT10/PACT13 and/or special sequencers according to PACT04).

If appropriate, the sequencer is extended by IO elements (PACT03, PACT22/24). In addition, additional PAEs may be added as data sources or data receivers.

Depending on the code source used, the method described in PACT08 may be used, which allows OpCodes of a PAE to be directly set via data buses, as well as data sources/targets to be specified.

The addresses of the data sources/targets may be transmitted by time stamp methods, for example. Furthermore, the bus may be used for transmitting the OpCodes.

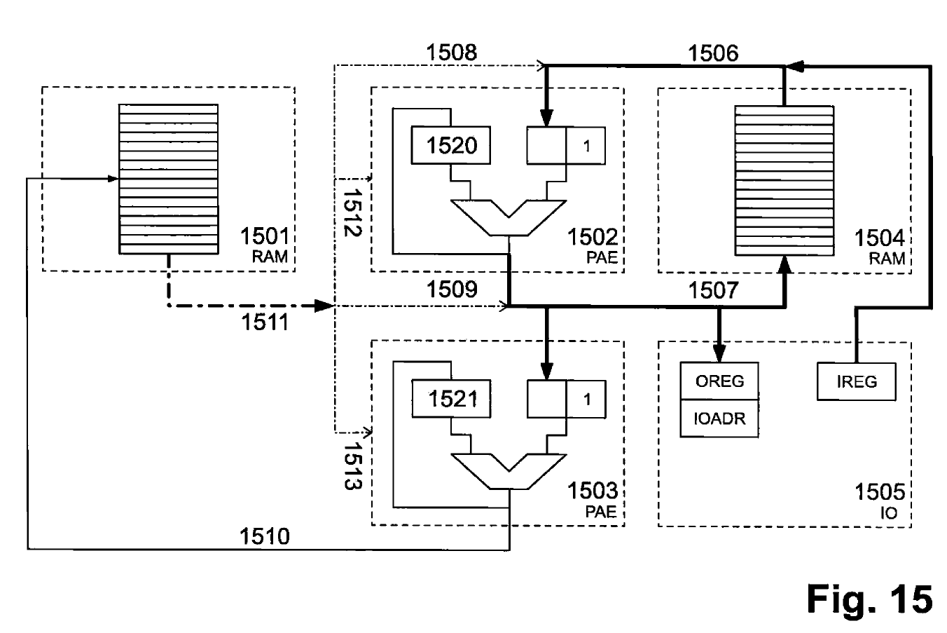

In an exemplary implementation according to FIG. 15, a sequencer has a RAM for storing the program (1501), a PAE for computing the data (ALU) (1502), a PAE for computing the program pointer (1503), a memory as a register set (1504), and an IO for external devices (1505).

The interconnection creates two bus systems: an input bus to ALU IBUS (1506) and an output bus from ALU OBUS (1507). A four-bit wide time stamp is assigned to each bus, which addresses the source IBUS-ADR (1508) and the target OBUS-ADR (1509), respectively.

The program pointer (1510) is transmitted from 1504 to 1501. 1501 returns the OpCode (1511). The OpCode is split into instructions for the ALU (1512) and the program pointer (1513), as well as the data addresses (1508, 1509). The SIMD procedures and bus systems described in the following may be used for splitting the bus.

1502 is configured as an accumulator machine and supports the following functions, for example;

| | |
|---|---|
| ld <reg> | load accumulator (1520) from register |
| add_sub <reg> | add/subtract register to/from accumulator |
| sl_sr | shift accumulator |
| rl_rr | rotate accumulator |
| st <reg> | write accumulator into register |

Three bits are needed for the instructions. A fourth bit specifies the type of operation: adding or subtracting, shifting right or left.

1502 delivers the ALU status carry to trigger port 0 and 0 to trigger port 1.

<reg> is coded as follows:

| | |
|---|---|
| 0-7 | data register in 1504 |
| 8 | input register (1521) program pointer |
| | computation |
| 9 | IO data |
| 10 | IO addresses |

Four bits are used for the addresses.

1503 supports the following operations via the program pointer:

| | |
|---|---|
| jmp | jump to address in input register (2321) |
| jt0 | jump to address in input register |
| | given when trigger0 set |
| jt1 | jump to address in input register |
| | given when trigger1 set |
| jt2 | jump to address in input register |
| | given when trigger2 set |
| jmpr | jump to PP plus address in input register |

Three bits are used for the instructions. A fourth bit specifies the type of operation: adding or subtracting.

OpCode 1511 is also split into three groups having four bits each: (1508, 1509), 1512, 1513. 1508 and 1509 may be identical for the given instruction set. 1512, 1513 are sent to the C register of the PAEs (see PACT22/24), for example, and decoded as instruction within the PAEs (see PACT08).

According to PACT13 and/or PACT11, the sequencer may be built into a more complex structure. For example, additional data sources, which may originate from other PAEs, are addressable via <reg>=11, 12, 13, 14, 15. Additional data receivers may also be addressed. Data sources and data receivers may have any structure, in particular PAEs.

It should be noted that the circuit illustrated needs only 12 bits of OpCode 1511. Thus, for a 32-bit architecture, 20 bits are optionally available for extending the basic circuit.

The multiplexer functions of the buses may be implemented according to the above-described time stamp method. Other designs are also possible; for example, PAEs may be used as multiplexer stages.

### SIMD Arithmetic Units and SIMD Bus Systems

When using reconfigurable technologies for executing algorithms, an important paradox occurs: On the one hand, complex ALUs are needed to obtain maximum computing performance, while the complexity should be minimum for the reconfiguration; on the other hand, the ALUs should be as simple as possible to facilitate efficient bit level processing; also, the reconfiguration and data management should be accomplished intelligently and quickly in such a way that it is programmed in an efficient and simple manner.

Previous technologies use a) very small ALUs having little reconfiguration support (FPGAs) and are efficient on the bit level; b) large ALUs (Chameleon) having little reconfiguration support, c) a mixture of large ALUs and small ALUs having reconfiguration support and data management (VPUs).

Since the VPU technology represents the most powerful technique, an optimum method should be built on this technology. It should be expressly pointed out that this method may also be used for the other architectures.

The surface needed for effective control of reconfiguration is relatively high with approx. 10,000 to 40,000 gates per PAE. If fewer gates are used, only simple sequence control may be possible, which considerably limits the programmability of VPUs and may rule out their use as general purpose processors. Since the object is to achieve a particularly rapid reconfiguration, additional memories must be provided, which again considerably increases the number of required gates.

Therefore, to obtain a reasonable compromise between reconfiguration complexity and computing performance, large ALUs (extensive functionality and/or large bit width) should be used. However, using excessively large ALUs decreases the usable parallel computing performance per chip. For excessively small ALUs (e.g., 4 bits), the complexity for configuring complex functions (e.g., 32-bit multiplication) is excessively high. In particular, the wiring complexity grows into ranges that may no longer be commercially feasible.

### 11.1 Use of SIMD Arithmetic Units

To reach an ideal compromise between processing of small bit widths, wiring complexity, and the configuration of complex functions, the use of SIMD arithmetic units is proposed. Arithmetic units having bit width m are split so that n individual blocks having bit width b=m/n are obtained. For each arithmetic unit it is specified via configuration whether an arithmetic unit is to operate without being split or whether it should be split into one or more blocks of the same or different bit widths. In other words, an arithmetic unit may also be split in such a way that different word widths are configured simultaneously within an arithmetic unit (e.g., 32-bit width split into 1×16, 1×8, and 2×4 bits). The data is transmitted between the PAEs in such a way that the split data words (SIMD-WORD) are combined to data words having bit width m and transmitted over the network as a packet.

The network always transmits a complete packet, i.e., all data words are valid within a packet and are transmitted according to the conventional handshake method.

### 11.1.1 Re-Sorting the SIMD-WORD

For efficient use of SIMD arithmetic units, a flexible and efficient re-sorting of the SIMD-WORD within a bus or between different buses may be required.

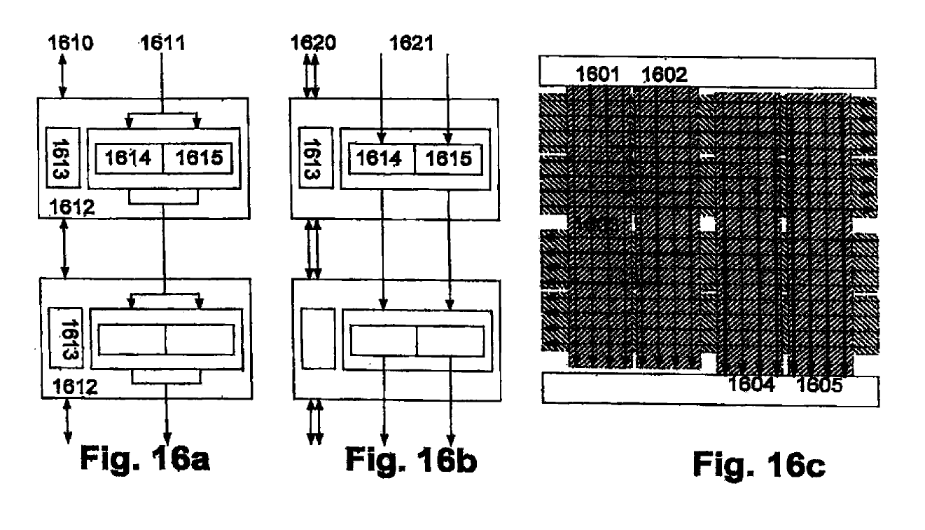

The bus switch according to FIGS. 5, 7b, c may be modified so that the individual SIMD-WORDs are interconnected in a flexible manner. For this purpose, the multiplexers are designed to be splittable according to the arithmetic units in such a way that the split may be defined by the configuration. In other words, instead of using one multiplexer having a width m bits per bus, for example, n individual multiplexers having a width b=m/n bits are used. It is thus possible to configure the data buses for a data width of b bits. The matrix structure of the buses (FIG. 5) permits the data to be re-sorted in a simple manner, as shown in FIG. 16c. A first PAE sends data via two buses (1601, 1602), which are each divided into four partial buses. A bus system (1603) connects the individual partial buses to additional partial buses located on the bus. A second PAE contains partial buses sorted differently on its two input buses (1604, 1605).

The handshakes of the buses between two PAEs having two arithmetic units (1614, 1615), for example, are logically gated in FIG. 16a so that a common handshake (1610) is generated for the re-sorted bus (1611) from the handshakes of the original buses. For example, a RDY may be generated for a re-sorted bus from a logical AND gating of all RDYs of the data for buses delivering to this bus. The ACK of a bus which delivers data may also be generated from an AND gating of the ACKs of all buses which process the data further.

The common handshake controls a control unit (1613) for managing the PAEs (1612). Bus 1611 is split into two arithmetic units (1614, 1615) within the PAE.

In a first embodiment variant, the handshakes are gated within each individual bus node. This permits a bus system having width m, containing n partial buses having width b, to be assigned a single handshake protocol.

In a further, particularly preferred embodiment, all bus systems are designed to have width b, which corresponds to the smallest implementable input/output data width b of a SIMD word. Corresponding to the width of the PAE data paths (m), an input/output bus is now composed of m/b−n partial buses of width b. For example, in the case of a smallest SIMD word width of 8 bits, a PAE having three 32-bit input buses and two 32-bit output buses actually has 3×4 eight-bit input buses and 2×4 eight-bit output buses.

All handshake and control signals are assigned to each of the partial buses.

The output of a PAE transmits them, using the same control signals, to all n partial buses. Incoming acknowledge signals of all partial buses are gated logically, for example, using an AND function. The bus systems are able to freely connect and independently route each partial bus. The bus system and, in particular, the bus nodes, do not process or gate the handshake signals of the individual buses independently of their routing, arrangement, and sorting. For data received by a PAE, the control signals of all n partial buses are gated in such a way that a control signal of overall validity, similar to a bus control signal, is generated for the data path.

For example, in a “dependent” operating mode according to the definition, RdyHold stages may be used for each individual data path, and the data is not received by the PAE until all RdyHold stages signal the presence of data.

In an “independent” operating mode according to the definition, the data of each partial bus is written individually into the input register of the PAE and acknowledged, which immediately frees the partial bus for a subsequent data transmission. The presence of all required data from all partial buses in the input registers is detected within the PAE by the appropriate logical gating of the RDY signals stored for each partial bus in the input register, whereupon the PAE starts the data processing.

One important advantage of this method may be that the SIMD property of PAEs has no specific influence on the bus system used. Only more buses (n) (1620) of a smaller width (b) and the associated handshakes (1621) are needed, as illustrated in FIG. 16b. The interconnection itself remains unaffected. The PAEs link and manage the control lines locally. This makes additional hardware unnecessary in the bus systems for managing and/or linking the control lines.

What is claimed:

1. An integrated configurable data processing circuit, comprising:
configurable elements arranged in a two-dimensional manner; and
an interconnect configurably connecting the configurable elements;
wherein:
each of at least some of the configurable elements includes:
at least two input registers adapted for receiving input data from the interconnect;
at least one configurable arithmetic-logic unit (ALU), each if the ALUs being adapted for:
processing arithmetic-logic operations on the input data;
producing a result in accordance with an arithmetic-logic operation;
processing m-bits wide input data, m being larger than 7; and
supporting single instruction, multiple data (SIM) operations by
splitting the input data into a plurality of data blocks; and
at least one output adapted for transferring the result to the interconnect.

2. The integrated configurable data processing circuit according to claim 1, wherein the integrated configurable data processing circuit is a Field Programmable Gate Array (FPGA).

3. The integrated configurable data processing circuit according to any one of claims 1 and 2, wherein the at least some of the configurable elements include at least one input data FIFO.

4. The integrated configurable data processing circuit according to any one of claims 1 and 2, wherein the integrated configurable data processing circuit is configurable at runtime.

5. The integrated configurable data processing circuit according to any one of claims 1 and 2, wherein the integrated configurable data processing circuit is reconfigurable at runtime.

6. The integrated configurable data processing circuit according to any one of claims 1 and 2, wherein each of the plurality of data blocks has the same width.

7. The integrated configurable data processing circuit according to claim 6, wherein the integrated configurable data processing circuit is configurable at runtime.

8. The integrated configurable data processing circuit according to claim 6, wherein the integrated configurable data processing circuit is reconfigurable at runtime.

9. The integrated configurable data processing circuit according to any one of claims 1 and 2, wherein the input data of the at least some of the configurable elements is split into 4 blocks of m divided by 4 (m/4) bits each.

10. The integrated configurable data processing circuit according to claim 9, wherein the integrated configurable data processing circuit is configurable at runtime.

11. The integrated configurable data processing circuit according to claim 9, wherein the integrated configurable data processing circuit is reconfigurable at runtime.

12. The integrated configurable data processing circuit according to any one of claims 1 and 2, wherein the plurality of data blocks of the at least some of the configurable elements have different widths.

13. The integrated configurable data processing circuit according to claim 12, wherein the integrated configurable data processing circuit is configurable at runtime.

14. The integrated configurable data processing circuit according to claim 12, wherein the integrated configurable data processing circuit is reconfigurable at runtime.

15. The integrated configurable data processing circuit according to any one of claims 1 and 2, wherein the each of the at least some of the configurable elements includes at least one feed-back channel from the at least one output of the at least one ALU to an operand input of the at least one ALU.

16. The integrated configurable data processing circuit according to claim 15, wherein the integrated configurable data processing circuit is configurable at runtime.

17. The integrated configurable data processing circuit according to claim 15, wherein the integrated configurable data processing circuit is reconfigurable at runtime.

18. The integrated configurable data processing circuit according to claim 15, wherein the feed-back channel supports data accumulation within the at least some of the configurable elements.

19. The integrated configurable data processing circuit according to claim 15, wherein each of the at least some of said configurable elements includes a status output.

20. The integrated configurable data processing circuit according to claim 19, wherein the status output is a carry status output to the interconnect.

21. The integrated configurable data processing circuit according to claim 19, wherein the status output is a zero status output to the interconnect.

22. The integrated configurable data processing circuit according to claim 19, wherein the status output is a negative status output to the interconnect.

23. The integrated configurable data processing circuit according to claim 19, wherein the status output is an underflow status output to the interconnect.

24. The integrated configurable data processing circuit according to claim 19, wherein the status output is an overflow status output to the interconnect.

25. The integrated configurable data processing circuit according to claim 19, wherein the status output is a comparison result output to the interconnect.
